(19) United States
(12) Patent Application Publication
(10) Pub. No.: US 2007/0217615 A1
(43) Pub. Date: Sep. 20, 2007

(54) Method and system for estimating a channel frequency response of a training symbol in a block transmission system

(75) Inventors: Sriram Rajagopal, Santa Clara, CA (US); Parikshith Sreebhashyam, Santa Clara, CA (US); Krishnamurthy Giridhar, Santa Clara, CA (US)

Correspondence Address: Beceem Communications Inc,;1st Floor, 3960 Freedom Circle, Santa Clara, CA, 95054, US

(73) Assignee: Beceem Communications, Inc.

(21) Appl. No.: 11/481,636

(22) Filed: Jul. 6, 2006

(30) Foreign Application Priority Data
Mar. 20, 2006 (IN) 391/MUM/2006

(51) Int. Cl. H04H 5/00

(52) U.S. Cl. 381/15

(57) ABSTRACT

A method and system for estimating channel frequency response at an ‘i’th pilot sub-carrier of a training symbol in a block transmission system is provided. The method comprises generating a matrix of pilot codes such that the number of rows of the matrix is equal to a block size (L+1), where L represents the number of adjacent pilot sub-carriers. A column of the matrix comprises the pilot codes corresponding to the adjacent pilot sub-carriers and the ‘i’th pilot sub-carrier of a signal. The number of columns of the matrix is approximately equal to the number of signals received by the receiver. The method comprises determining whether the matrix is invertible and calculates the channel frequency response at the ‘i’th pilot sub-carrier corresponding to the desired signal in response to determining whether the matrix is invertible.

### RELATED APPLICATION DATA

This application claims priority to and incorporates by reference India provisional application serial number 391/MUM/2006 filed on Mar. 20, 2006, titled “Method and System for Estimating a Channel Frequency response of a training symbol in a Block transmission system”

### BACKGROUND

The invention relates to a block transmission system. More particularly, the invention relates to a method and system for estimating a channel frequency response of a training symbol in a block transmission system (e.g. a frequency reuse system).

Orthogonal Frequency-Division Multiplexing (OFDM) systems employing multiple transmit antennas typically require a preamble or a mid-amble symbol to enable a receiver to estimate the channel frequency responses of multiple transmit antennas. In the presence of strong Co-Channel Interference (CCI) using the preamble or mid-amble, pilots sub-carriers may result in poor channel frequency response estimation. In these conditions, the channel frequency response at the pilot sub-carriers can be improved by using a Least Squares (LS) solver. However, if the matrix pf LS solver is not invertible, the computation involved in channel frequency response estimation increases.

There is therefore a need for a robust channel estimation method and system that estimates channel frequency response with less computation even if the matrix is not invertible. Further, there is a need for a method and system that enables good quality channel frequency response estimation even in the presence of strong CCI.

### SUMMARY

A method and system of an embodiment enhances the channel estimation quality of channel frequency response of a desired signal in Co-Channel Interference (CCI) limited situations.

A method and system of an embodiment estimates channel frequency response with fewer computations when the matrix is not invertible.

A method and system for estimating channel frequency response at an ‘i’th pilot sub-carrier of a training symbol in a block transmission system is provided. The channel frequency response estimation comprises generating a matrix of pilot codes such that the number of rows of the matrix is approximately equal to a block size (L+1), where L represents the number of adjacent pilot sub-carriers. A column of the matrix comprises the pilot codes corresponding to the adjacent pilot sub-carriers and the ‘i’th pilot sub-carrier of a signal. The number of columns of the matrix is approximately equal to a number of signals received by the receiver. The channel frequency response estimation comprises determining whether the matrix is invertible and calculates the channel frequency response at the ‘i’th pilot sub-carrier corresponding to the desired signal in response to determining whether the matrix is invertible.

### BRIEF DESCRIPTION OF THE DRAWINGS

FIG.1 is a flowchart for estimating a channel frequency response at an ‘i’th pilot sub-carrier of a training symbol in a block transmission system, in accordance with an embodiment.

FIG.2 is a flowchart for calculating a channel frequency response at the ‘i’th sub-carrier, in accordance with an embodiment.

FIG.3 is a block diagram of a receiver, in accordance with an embodiment.

### DETAILED DESCRIPTION OF DRAWINGS

Methods and systems for estimating a channel frequency response in a block transmission system are described herein. Examples of the block transmission system include Orthogonal Frequency-Division Multiplexing (OFDM), Multi-Carrier Code Division Multiple Access (MC-CDMA), Orthogonal Frequency Division Multiple Access (OFDMA), Discrete Multi-Tone (DMT) and the like. The IEEE 802.16d and 802.16e wireless Metropolitan Area Network (MAN) standards, which use OFDM-like technology, are also included. In various embodiments, the block transmission system is a frequency reuse system but is not so limited. In an example embodiment, the block transmission system is a frequency reuse-1 system.

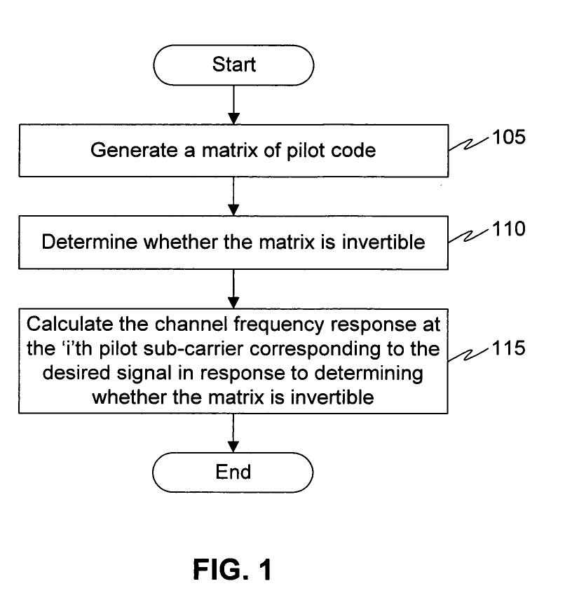

FIG.1 is a flowchart for estimating a channel frequency response at an ‘i’th pilot sub-carrier of a training symbol in a block transmission system, in accordance with an embodiment. In an embodiment, the training symbol is a reuse-1/3 preamble symbol but is not so limited. In another embodiment, the training symbol is a reuse-1 (Multi Input Multi Output (MIMO) mid-amble symbol.

At 105, a matrix of pilot codes is generated. The number of rows of the generated matrix is approximately equal to a block size (L+1), where L represents the number of adjacent pilot sub-carriers. Further, each adjacent pilot sub-carrier has a channel frequency response approximately equal to the channel frequency response of the ‘i’th pilot sub-carrier of a signal. In an embodiment, L can vary based on the channel correlation, and the training symbol on which the estimation is performed. In another embodiment, L can further vary based on the number of undesired signals (for example, interfering signals). For example, in case of an IEEE 802.16e OFDMA system, L=3, i.e., 6 tones for Single Input Single Output (SISO) reuse-1/3 preamble, or 8 tones for MIMO four antenna reuse-1 mid-amble. The value of L may be increased if further averaging is required at the expense of channel correlation loss. For example, in Co-Channel Interference (CCI) limiting situations, the value of L may be increased to estimate more interfering channels, even though it is achieved at the expense of channel correlation loss. In another example, the value of L may be increased to estimate flat channel frequency response to accrue more noise averaging gain. In an embodiment, the value of L is greater than or equal to the total number of channel frequency responses of the undesired signals but is not so limited. Further, the columns of the matrix comprise the pilot codes corresponding to the adjacent pilot sub-carriers and the ‘i’th pilot sub-carrier of a signal. The number of columns of the matrix is approximately equal to the number of signals received by the receiver. The receiver, for example, may receive a desired signal and at least one undesired signal.

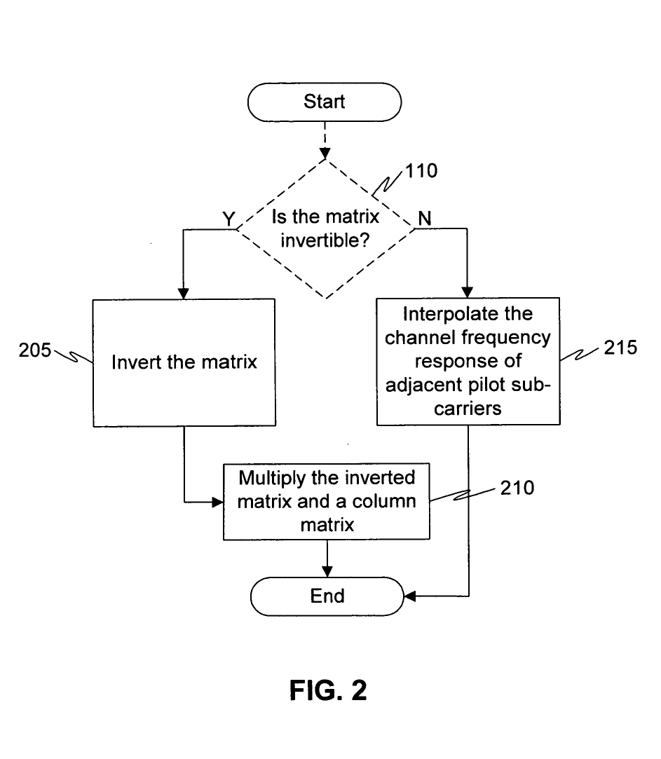

At 110, it is determined whether the matrix is invertible. At 115, the channel impulse response at the ‘i’th pilot sub-carrier signal is calculated (corresponds to the desired signal) in response to determining whether the matrix is invertible. This is further explained below with reference to FIG. 2.

In an embodiment, if the matrix is not invertible, rows of the matrix are augmented selectively in order to increase the probability of inversion, as the channel responses are approximately equal over the frequency domain. The augmentation of the matrix row may for example, depend on the coherence bandwidth or delay spread of the desired signal that can be estimated at the receiver.

FIG.2 is a flowchart for calculating a channel frequency response at the ‘i’th sub-carrier, in accordance with an embodiment. At 205, the matrix is inverted, if it is determined, at 110 (FIG. 1) that the matrix is invertible. At 210, the inverted matrix is then multiplied with a column matrix, to calculate the channel frequency response of the ‘i’th pilot sub-carrier of the desired signal. In various embodiments, the column matrix comprises values measured at the receiver corresponding to the adjacent pilot sub-carriers and the ‘i’th pilot sub-carrier but the embodiments are not so limited.

At 215, the channel frequency response of the adjacent pilot sub-carriers is interpolated to calculate the channel frequency response of the ‘i’th pilot sub-carrier of the desired signal, if it is determined at 110 (FIG. 1) that the matrix is singular (i.e., not invertible). The interpolation may be performed after the channel frequency response of each pilot sub-carrier of the training symbol of the desired signal is estimated if the corresponding matrices are invertible. Therefore, the interpolation may be performed after the channel frequency response for all pilot tones with invertible matrices has been obtained. In an embodiment, interpolation is performed in accordance with a spline interpolating algorithm but is not so limited. In another embodiment, interpolation is performed based a linear interpolating algorithm.

In various embodiments, a channel frequency response is estimated that corresponds to each signal at an ‘i’th pilot sub-carrier of a training symbol in a block transmission system. In other words, a channel frequency response of both the desired signal and at least one undesired signal can be estimated. For example, in a receiver with interference resulting from J-1 undesired signals, a channel impulse response of a kth sub-carrier of each signal can be estimated as follows:

$$[ \begin{matrix}{C}_{1 , k - \frac{L - 1}{2} P} & ⋯ & ⋯ & ⋯ & {C}_{J , k - \frac{L - 1}{2} P} \\ ⋮ & ⋰ & & & ⋮ \\ ⋮ & & ⋰ & & ⋮ \\ ⋮ & & & ⋰ & ⋮ \\ {C}_{1 , k + \frac{L - 1}{2} P} & ⋯ & ⋯ & ⋯ & {C}_{J , k - \frac{L - 1}{2} P}\end{matrix} ] [ \begin{matrix}{H}_{1 , k} \\ ⋮ \\ ⋮ \\ ⋮ \\ {H}_{J , k}\end{matrix} ] = [ \begin{matrix}{R}_{k - \frac{L - 1}{2} P} \\ ⋮ \\ ⋮ \\ ⋮ \\ {R}_{k + \frac{L - 1}{2} P}\end{matrix} ] \qquad ( 1 )$$

where, C_{m,n} represents a pilot code corresponding to an m^{th} signal and n^{th} pilot sub-carrier; H_{m,k} represents a channel frequency response corresponding to the m^{th} signal and k^{th} pilot sub-carrier; and Rₖ represents a value measured at the receiver corresponding to the kth pilot sub-carrier.

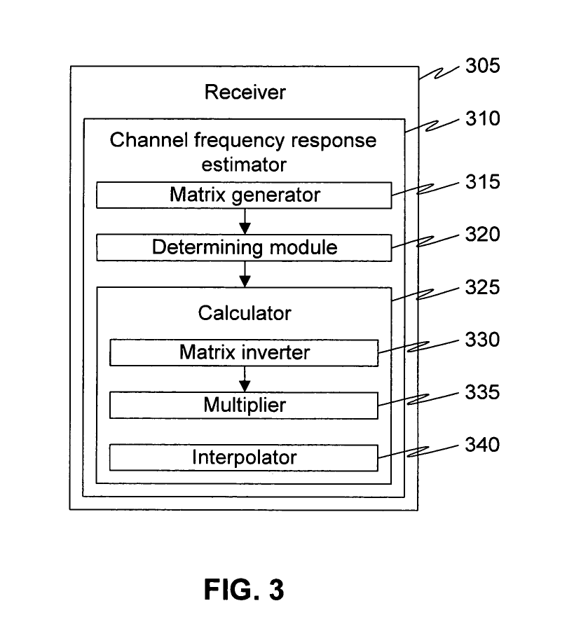

FIG.3 is a block diagram of a receiver, in accordance with an embodiment. One or more components of the receiver 305 are configured to and/or are coupled to other components that are configured to perform the operations described above with reference to FIG. 1 and FIG. 2. Receiver 305 comprises a channel frequency response estimator 310. Channel frequency response estimator 310 comprises a matrix generator 315, a determining module 320 and a calculator 325 coupled and configured to estimate a channel frequency response corresponding to each signal at an ‘i’th pilot sub-carrier of a training symbol in a block transmission system.

Matrix generator 315 is configured to generate a matrix of pilot codes such that the number of rows of the matrix is approximately equal to a block size (L+1) and the number of columns of the matrix is approximately equal to number of signals received by receiver 305, as described above with reference to FIG. 1. In an embodiment, receiver 305 is configured to receive uplink signals; as a result, receiver 305 is installed in a base station of the block transmission system but is not so limited. In another embodiment, receiver 305 is configured to receive downlink signals; as a result, receiver 305 is installed in a subscriber station but is not so limited.

Determining module 320 is configured to determine whether the matrix is invertible. Calculator 325 is configured to calculate the channel frequency response corresponding to each signal or a desired signal at the ‘i’th pilot sub-carrier in response to determining whether the matrix is invertible. Calculator 325 comprises a matrix inverter 330, a multiplier 335 and an interpolator 340 coupled and configured to calculate the channel frequency response, in response to a determining whether the matrix is invertible.

Matrix inverter 330 is configured to invert the matrix if the matrix is invertible. Multiplier 335 is configured to multiply the inverted matrix with a column matrix and to calculate the channel frequency response of the ‘i’th pilot sub-carrier of the desired signal/each signal.

Interpolator 340 is configured to interpolate the channel frequency response of the adjacent pilot sub-carriers to calculate the channel frequency response of the ‘i’th pilot sub-carrier of the desired signal, if the matrix is singular (i.e., not invertible). Interpolator 340 may perform interpolation after the channel frequency response of each sub-carrier of the training symbol of the desired signal/each signal is estimated if the corresponding matrices are invertible. In an embodiment, interpolation is performed using a spline interpolating algorithm but is not so limited. In another embodiment, interpolation is performed using a linear interpolating algorithm but is not so limited.

The various embodiments described herein provide a method and system that exploits the spatial correlation of the channel frequency response with the coherence bandwidth to jointly estimate the channel frequency responses of two or more signals received by a receiver. Further, the various embodiments provide a method and system that utilize a combination of Least Square (LS) solver and an interpolator to estimate channel frequency response of sub-carriers that have a corresponding singular matrix.

The various embodiments described herein provide a method and system that enhances the channel estimation quality of channel frequency response of a desired signal in CCI limited situations. Further, modifying the block size can vary the complexity of the method.

What is claimed is:

1. A method for estimating a channel frequency response at an ‘i’th pilot sub-carrier of a training symbol in a block transmission system, the channel frequency response being estimated by a receiver, the block transmission system being a frequency reuse system, the method comprising:
a. generating a matrix of pilot codes, the number of rows of the matrix being approximately equal to a block size (L+1), L representing the number of adjacent pilot sub-carriers, each adjacent pilot sub-carrier having a channel frequency response approximately equal to the channel frequency response of the ‘i’th pilot sub-carrier, a column of the matrix comprising the pilot codes corresponding to the adjacent pilot sub-carriers and the ‘i’th pilot sub-carrier of a signal, the number of columns of the matrix being equal to number of signals received by the receiver, the receiver receiving a desired signal and at least one undesired signal;
b. determining whether the matrix is invertible; and
c. calculating the channel frequency response at the ‘i’th pilot sub-carrier corresponding to the desired signal in response to determining whether the matrix is invertible.

2. The method of claim 1, wherein calculating comprises:
a. inverting the matrix when the matrix is invertible; and
b. multiplying the inverted matrix and a column matrix, the column matrix comprising values measured at the receiver corresponding to the adjacent pilot sub-carriers and the ‘i’th pilot sub-carrier.

3. The method of claim 1, wherein calculation comprises interpolating the channel frequency response of adjacent pilot sub-carriers when the matrix is singular.

4. The method of claim 3, wherein the interpolating is performed using a spline interpolation algorithm.

5. The method of claim 3, wherein the interpolating is performed using a linear interpolation algorithm.

6. The method of claim 1, wherein the training symbol is a mid-amble symbol.

7. The method of claim 1, wherein the training symbol is a preamble symbol.

8. A method for estimating a channel frequency response corresponding to each signal at an ‘i’th pilot sub-carrier of a training symbol in a block transmission system, the channel frequency response estimated by a receiver, the block transmission system being a frequency reuse system, the method comprising:
a. generating a matrix of pilot codes, the number of rows of the matrix approximately equal to a block size (L+1), L representing a number of adjacent pilot sub-carriers, each adjacent pilot sub-carrier having a channel frequency response approximately equal to the channel frequency response of the ‘i’th pilot sub-carrier, a column of the matrix comprising the pilot codes corresponding to the adjacent pilot sub-carriers and the ‘i’th pilot sub-carrier of a signal, the number of columns of the matrix approximately equal to number of signals received by the receiver, the receiver receiving a desired signal and at least one undesired signal;
b. determining whether the matrix is invertible; and
c. calculating the channel frequency response corresponding to each signal at the ‘i’th pilot sub-carrier in response to determining whether the matrix is invertible.

9. A receiver comprising a channel frequency response estimator, the channel frequency response estimator configured to estimate a channel frequency response corresponding to each signal at an ‘i’th pilot sub-carrier of a training symbol in a block transmission system, wherein the block transmission system includes a frequency reuse system, wherein the channel frequency response estimator comprises:
a. a matrix generator configured to generate a matrix of pilot codes, the number of rows of the matrix approximately equal to a block size (L+1), L representing the number of adjacent pilot sub-carriers, each adjacent pilot sub-carrier having a channel frequency response approximately equal to the channel frequency response of the ‘i’th pilot sub-carrier, a column of the matrix comprising the pilot codes corresponding to the adjacent pilot sub-carriers and the ‘i’th pilot sub-carrier of a signal, the number of columns of the matrix approximately equal to number of signals received by the receiver, the receiver configured to receive a desired signal and at least one undesired signal;
b. a determining module configured to determine whether the matrix is invertible; and
c. a calculator configured to calculate the channel frequency response corresponding to each signal at the ‘i’th pilot sub-carrier in response to determining whether the matrix is invertible.

10. The receiver of claim 9, wherein the calculator comprises:
a. a matrix inverter configured to invert the matrix when the matrix is invertible;
and
b. a multiplier configured to multiply the inverted matrix and a column matrix, the column matrix comprising values measured at the receiver corresponding to the adjacent pilot sub-carriers and the ‘i’th pilot sub-carrier.

11. The receiver of claim 9, wherein the calculator comprises an interpolator configured to interpolate the channel frequency response of adjacent pilot sub-carriers when the matrix is singular.

12. The receiver of claim 10, wherein the calculator further comprises an interpolator configured to interpolate the channel frequency response of adjacent pilot sub-carriers when the matrix is singular.

13. The receiver of claim 12, wherein the interpolator is configured to perform spline interpolation.

14. The receiver of claim 12, wherein the interpolator is configured to perform linear interpolation.

15. The receiver of claim 9, wherein the receiver is configured to receive uplink signals.

16. The receiver of claim 9, wherein the receiver is configured to receive downlink signals.

17. The receiver of claim 16, wherein the training symbol is a mid-amble symbol.

18. The receiver of claim 16, wherein the training symbol is a preamble symbol.

19. The receiver of claim 9, wherein the block transmission system includes a frequency reuse-1 system.
